(19) United States
(12) Patent Application Publication
(10) Pub. No.: US 2024/0348627 A1
(43) Pub. Date: Oct. 17, 2024

(54) APPLICATION ACCESS ANALYZER

(71) Applicant: Palo Alto Networks, Inc., Santa Clara, CA (US)

(72) Inventors: Sameer D. Merchant, Sunnyvale, CA (US); Iqrar Jabbar Patel, San Jose, CA (US); Dinesh Ranjit, Milpitas, CA (US); Rajesh Bhagwat, Los Gatos, CA (US); Shivangi Indradeo Sharma, Los Gatos, CA (US); Kartik Mohanram, Pittsburgh, PA (US); Navneet Yadav, Saratoga, CA (US)

(21) Appl. No.: 18/429,166

(22) Filed: Jan. 31, 2024

Related U.S. Application Data
(60) Provisional application No. 63/459,494, filed on Apr. 14, 2023.
(60) Provisional application No. 63/459,492, filed on Apr. 14, 2023.
(60) Provisional application No. 63/459,500, filed on Apr. 14, 2023.

(51) Int. Cl. H04L 9/40

(52) U.S. Cl. CPC H04L 63/1416

(57) ABSTRACT

Techniques for an Application Access Analyzer are disclosed. In some embodiments, a system/process/computer program product for an Application Access Analyzer includes monitoring access to an application over a network; automatically determining a root cause of an issue (e.g., an anomaly in network connectivity, performance degradation, and/or a permission denial and/or policy blocking) associated with the access to the application over the network for a user (e.g., or a group of users) using an application access analyzer; and performing an action in response to determining the root cause of the issue associated with the access to the application over the network.

### CROSS REFERENCE TO OTHER APPLICATIONS

This application claims priority to U.S. Provisional Patent Application No. 63/459,494 entitled APPLICATION ACCESS ANALYZER filed Apr. 14, 2023, U.S. Provisional Patent Application No. 63/459,492 entitled SECURITY POLICY ANALYSIS-DEVOPS APPROACH filed Apr. 14, 2023, and U.S. Provisional Patent Application No. 63/459,500 entitled TOPOLOGICAL CO-RELATION filed Apr. 14, 2023, all of which are incorporated herein by reference for all purposes.

### BACKGROUND OF THE INVENTION

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

### BRIEF DESCRIPTION OF THE DRAWINGS

Various embodiments of the invention are disclosed in the following detailed description and the accompanying drawings.

FIG. 1 illustrates an example of an environment in which malicious applications (“malware”) are detected and prevented from causing harm.

FIG. 2A illustrates an embodiment of a data appliance.

FIG. 2B is a functional diagram of logical components of an embodiment of a data appliance.

FIG. 3 illustrates an example of logical components that can be included in a system for analyzing samples.

FIG. 4 is an example Secure Access Service Edge (SASE) and network environment that illustrates technical challenges for application access visibility in accordance with some embodiments.

FIGS. 5A and 5B illustrate an example interface for an Application Access Analyzer (AAA) in accordance with some embodiments.

FIG. 6A illustrates a service architecture for the AAA in accordance with some embodiments.

FIG. 6B is a table summarizing data sources used for example issues that are analyzed using the AAA Service in accordance with some embodiments.

FIG. 6C is a sequence diagram for an App Connectivity Analyzer using the AAA Service in accordance with some embodiments.

FIG. 7 illustrates the AAA in operation in accordance with some embodiments.

FIG. 8 illustrates an example implementation of the AAA that incorporates domain knowledge in the form of playbooks and can perform playbook analysis through execution of Directed Acyclic Graphs (DAGs) in accordance with some embodiments.

FIG. 9 is a flow diagram of a process for the AAA Service in accordance with some embodiments.

FIG. 10 is another flow diagram of a process for the AAA Service in accordance with some embodiments.

FIG. 11 is another flow diagram of a process for the AAA Service in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as one or more software applications on various types of devices, such as computer servers, gateways, network/routing devices (e.g., network routers), and data appliances (e.g., security appliances or other types of special purpose devices), and in various implementations, certain operations can be implemented in special purpose hardware, such as an ASIC or FPGA.

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QOS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)) as well as CN Series container next generation firewalls. For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

### Overview of Techniques for an Application Access Analyzer

Generally, existing Information Technology (IT) operations have to go through thousands to millions of logs and a multitude of devices in enterprise infrastructures to identify application connectivity issues for users or groups of users. Troubleshooting and debugging connectivity issues typically require domain knowledge expertise, such as network architecture, routing/switching, server configuration, understanding of complex network security policies, and vendor specific Operating System (OS) and Command Line Interface (CLI) knowledge. As such, this significantly increases the person hours and mean time to detect and resolve the application connectivity issues.

Specifically, identifying Software as a Service (SaaS)/Private application connectivity issues in a large network infrastructure is technically challenging due to vast areas of domains where thorough check and analysis is generally required. This leads to a significant increase in mean time to detect and remediate issues in SaaS/Private application (App) connectivity issues, particularly in a large network infrastructure. As such, many Secure Access Service Edge (SASE) providers and enterprise organizations are attempting to solve this problem through different ways using artificial intelligence (AI) and/or Machine Learning (ML) technology. Automating detection and remediation of application connectivity issues can reduce the Mean Time To Recovery (MTTR) and operational costs to the organization. Further, providing a solution that facilitates an automated detection and remediation of application connectivity issues can help SASE providers to increase their customer base with quality product and customer satisfaction.

Accordingly, new and improved solutions that facilitate an application access analyzer are disclosed with respect to various embodiments.

Specifically, an Application Access Analyzer (AAA) is disclosed that provides an interface (e.g., a natural language (NL) query interface) to operators (e.g., IT/admin, such as for an IT help desk or other technology support personnel/users) to detect application reachability, connectivity, and access/permission issues. The disclosed AAA facilitates auto remediation. As an example, the AAA provides an actionable verdict for a query submitted by the operator with comprehensive details of analysis and checks performed in different categories (e.g., distinct domains, including user/endpoint analysis, networking analysis, and security policy analysis, such as further described below). Specifically, the AAA auto-discovers the network topology that a given user (e.g., the user(s) specified in the query) uses to access a given application (e.g., the SaaS/Private App specified in the query), analysis of operational state of an underlying network infrastructure, a user authentication analysis, checks on health and reachability of Domain Name System (DNS) and Authentication (Auth) servers that the user reaches before accessing the application, and security policy reasoning specific to the user or user groups for any access/permission issues.

Actionable verdict, root cause analysis, and pinpointing the problem significantly reduces the mean time to resolve application connectivity issues. Actionable verdict, root cause analysis, and pinpointing the problem also saves the hassle and time operators would be required to otherwise perform by following a runbook/playbook and debugging multiple devices, which generally requires domain knowledge expertise.

As an example, the disclosed AAA can be used for checking connectivity issues between one or more of the following: (1) a user, users, and/or a group of users to a SaaS application from mobile user gateways; (2) a user, users, and/or a group of users to a private application hosted on premise data centers or on a remote branch office; and (3) a user, users, and/or a group of users to remote site connectivity to a remote branch or data center.

In some embodiments, a system/process/computer program product for an application access analyzer (AAA) includes monitoring access to an application over a network; automatically determining a root cause of an issue (e.g., an anomaly in network connectivity, performance degradation, and/or a permission denial and/or policy blocking) associated with the access to the application over the network for a user using an application access analyzer; and performing an action in response to determining the root cause of the issue associated with the access to the application over the network for the user.

In one embodiment, the disclosed AAA can be used to determine a root cause of an application access issue by correlating a plurality of data sources across a plurality of domains (e.g., network, authentication, DNS, SaaS/Private App health, security policy configuration, etc.) using AI and ML as will be further described below.

In one embodiment, the disclosed AAA can be used to automatically detect an anomaly in network connectivity and/or a performance degradation (e.g., an anomaly in network connectivity and/or a performance degradation, such as based on configurable thresholds for determining reachability and/or performance degradation to given apps for a user(s) based on their location/access point) as will be further described below.

In one embodiment, the disclosed AAA can be used to generate human consumable/understandable and actionable verdict analysis that greatly reduces the mean time to detect and remediate application connectivity issues as will be further described below.

In one embodiment, the disclosed AAA can be used to perform an exhaustive analysis of various troubleshooting domains within a short period of time (e.g., a few minutes), which would otherwise typically require many hours to troubleshoot each domain, such as will be further described below.

In one embodiment, the disclosed AAA can be used to perform an analysis that includes identifying issues in a network infrastructure, customer network services, client connectivity issues, SaaS/private application (app) health, and reachability issues as will be further described below. For example, the disclosed AAA can provide an actionable summary of each troubleshooting domain, and the operator does not need to have domain knowledge expertise to detect and remediate the issue(s).

In one embodiment, the disclosed AAA can automatically discover (autodiscover) a network topology that would be used by a user to access the application and perform analysis for possible application access issues.

In one embodiment, the disclosed AAA can be used to provide a security posture evaluation by building a unified logical model of computation for security policies of the firewall.

In one embodiment, the disclosed AAA can be used for managing and maintaining the track of network topology issues, configuration issues with networking, network services, and security policy, which can often be cumbersome and error prone, such as will be further described below. For example, the disclosed AAA can provide a comprehensive analysis of each of these domains with a convenient natural language (NL) query interface.

In one embodiment, the disclosed AAA incorporates domain knowledge in the form of playbooks and can perform playbook analysis through execution of Directed Acyclic Graphs (DAGs) (e.g., implemented as computational DAGs as further described below).

In one embodiment, the disclosed AAA can be used to significantly reduce operational and support costs for enterprises and their users for accessing their SaaS/Private Apps.

In an example implementation, the disclosed AAA is implemented as a Prisma AI Operations (AIOPs) platform that provides proactive service level management across customers globally and is designed for use by Network Operations Center (NOC) personnel supporting SASE customers, such as will be further described below. Specifically, the Prisma AIOPs platform provides proactive monitoring, alerting, problem isolation, and playbook-driven remediation to provide SLA (MTTK/I, MTTR) as desired/required by customers.

Accordingly, new and improved security solutions that facilitate an application access analyzer are disclosed in accordance with some embodiments.

These and other embodiments and examples for an application access analyzer (AAA) will be further described below.

### Example System Environments for an Application Access Analyzer

Accordingly, in some embodiments, the disclosed techniques include providing a security platform (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, such as PANOS executing on a virtual/physical NGFW solution commercially available from Palo Alto Networks, Inc. or another security platform/NFGW, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) configured to provide DPI capabilities (e.g., including stateful inspection), for example, which can be provided in part or in whole as a SASE security solution, in which the cloud-based security solution (e.g., SASE) can be monitored using the disclosed techniques for an application access analyzer, as further described below.

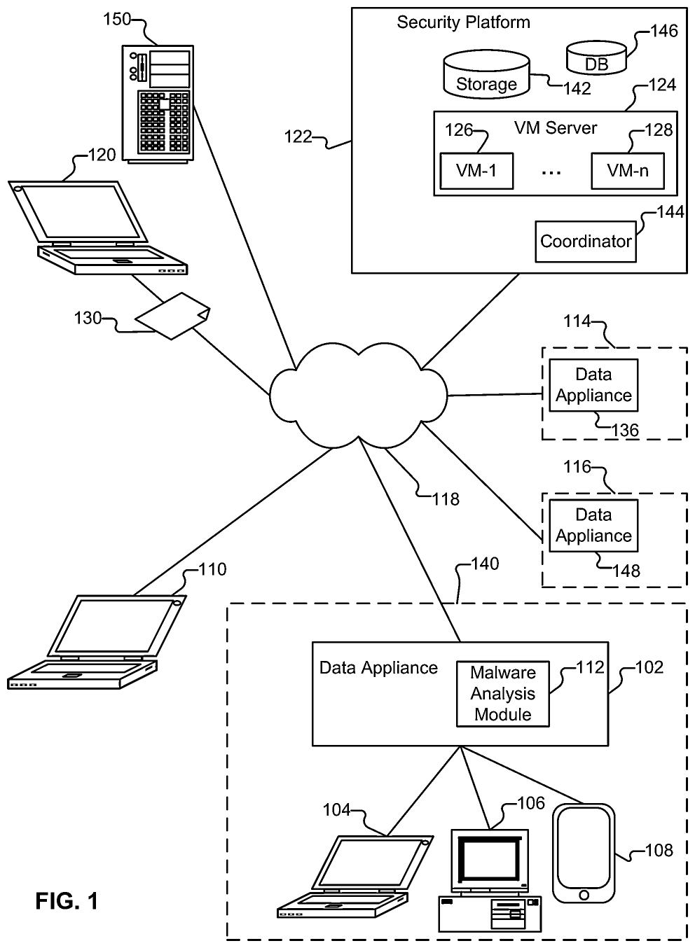

FIG. 1 illustrates an example of an environment in which malicious applications (“malware”) are detected and prevented from causing harm. As will be described in more detail below, malware classifications (e.g., as made by security platform 122) can be variously shared and/or refined among various entities included in the environment shown in FIG. 1. And, using techniques described herein, devices, such as endpoint client devices 104-110, can be protected from such malware (e.g., including previously unknown/new variants of malware, such as C2 malware).

“Malware” as used herein refers to an application that engages in behaviors, whether clandestinely or not (and whether illegal or not), of which a user does not approve/would not approve if fully informed. Examples of malware include ransomware, Trojans, viruses, rootkits, spyware, hacking tools, etc. One example of malware is a desktop/mobile application that encrypts a user's stored data (e.g., ransomware). Another example of malware is C2 malware, such as similarly described above. Other forms of malware (e.g., keyloggers) can also be detected/thwarted using the disclosed techniques for sample traffic based self-learning malware detection as will be further described herein.

Techniques described herein can be used in conjunction with a variety of platforms (e.g., servers, computing appliances, virtual/container environments, desktops, mobile devices, gaming platforms, embedded systems, etc.) and/or for automated detection of a variety of forms of malware (e.g., new and/or variants of malware, such as C2 malware, etc.). In the example environment shown in FIG. 1, client devices 104-108 are a laptop computer, a desktop computer, and a tablet (respectively) present in an enterprise network 140. Client device 110 is a laptop computer present outside of enterprise network 140.

Data appliance 102 is configured to enforce policies regarding communications between client devices, such as client devices 104 and 106, and nodes outside of enterprise network 140 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, web site content, files exchanged through instant messaging programs, and/or other file transfers. In some embodiments, data appliance 102 is also configured to enforce policies with respect to traffic that stays within enterprise network 140.

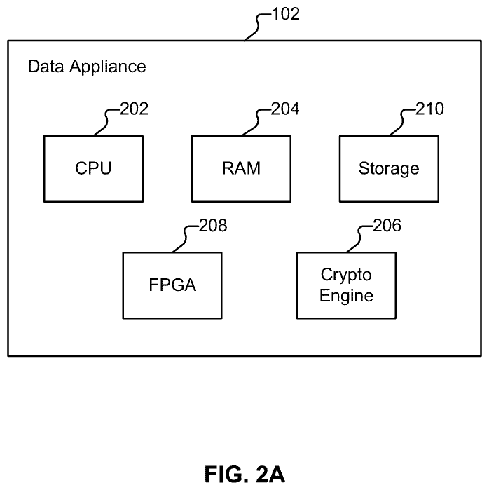

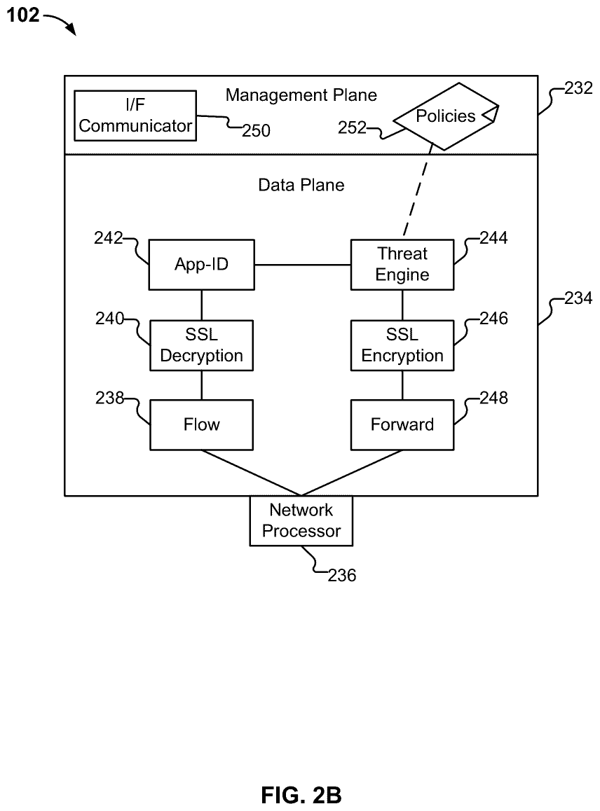

An embodiment of a data appliance is shown in FIG. 2A. The example shown is a representation of physical components that are included in data appliance 102, in various embodiments. Specifically, data appliance 102 includes a high performance multi-core Central Processing Unit (CPU) 202 and Random Access Memory (RAM) 204. Data appliance 102 also includes a storage 210 (such as one or more hard disks or solid state storage units). In various embodiments, data appliance 102 stores (whether in RAM 204, storage 210, and/or other appropriate locations) information used in monitoring enterprise network 140 and implementing disclosed techniques. Examples of such information include application identifiers, content identifiers, user identifiers, requested URLs, IP address mappings, policy and other configuration information, signatures, hostname/URL categorization information, malware profiles, and machine learning (ML) models (e.g., such as for sample traffic based self-learning malware detection). Data appliance 102 can also include one or more optional hardware accelerators. For example, data appliance 102 can include a cryptographic engine 206 configured to perform encryption and decryption operations, and one or more Field Programmable Gate Arrays (FPGAs) 208 configured to perform matching, act as network processors, and/or perform other tasks.

Functionality described herein as being performed by data appliance 102 can be provided/implemented in a variety of ways. For example, data appliance 102 can be a dedicated device or set of devices. The functionality provided by data appliance 102 can also be integrated into or executed as software on a general purpose computer, a computer server, a gateway, and/or a network/routing device. In some embodiments, at least some services described as being provided by data appliance 102 are instead (or in addition) provided to a client device (e.g., client device 104 or client device 110) by software executing on the client device.

Whenever data appliance 102 is described as performing a task, a single component, a subset of components, or all components of data appliance 102 may cooperate to perform the task. Similarly, whenever a component of data appliance 102 is described as performing a task, a subcomponent may perform the task and/or the component may perform the task in conjunction with other components. In various embodiments, portions of data appliance 102 are provided by one or more third parties. Depending on factors such as the amount of computing resources available to data appliance 102, various logical components and/or features of data appliance 102 may be omitted and the techniques described herein adapted accordingly. Similarly, additional logical components/features can be included in embodiments of data appliance 102 as applicable. One example of a component included in data appliance 102 in various embodiments is an application identification engine which is configured to identify an application (e.g., using various application signatures for identifying applications based on packet flow analysis). For example, the application identification engine can determine what type of traffic a session involves, such as Web Browsing-Social Networking; Web Browsing-News; SSH; and so on.

FIG. 2B is a functional diagram of logical components of an embodiment of a data appliance. The example shown is a representation of logical components that can be included in data appliance 102 in various embodiments. Unless otherwise specified, various logical components of data appliance 102 are generally implementable in a variety of ways, including as a set of one or more scripts (e.g., written in Java, python, etc., as applicable).

As shown, data appliance 102 comprises a firewall, and includes a management plane 232 and a data plane 234. The management plane is responsible for managing user interactions, such as by providing a user interface for configuring policies and viewing log data. The data plane is responsible for managing data, such as by performing packet processing and session handling.

Network processor 236 is configured to receive packets from client devices, such as client device 108, and provide them to data plane 234 for processing. Whenever flow module 238 identifies packets as being part of a new session, it creates a new session flow. Subsequent packets will be identified as belonging to the session based on a flow lookup. If applicable, SSL decryption is applied by SSL decryption engine 240. Otherwise, processing by SSL decryption engine 240 is omitted. Decryption engine 240 can help data appliance 102 inspect and control SSL/TLS and SSH encrypted traffic, and thus help to stop threats that might otherwise remain hidden in encrypted traffic. Decryption engine 240 can also help prevent sensitive content from leaving enterprise network 140. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 242 is configured to determine what type of traffic a session involves. As one example, application identification engine 242 can recognize a GET request in received data and conclude that the session requires an HTTP decoder. In some cases, such as a web browsing session, the identified application can change, and such changes will be noted by data appliance 102. For example, a user may initially browse to a corporate Wiki (classified based on the URL visited as “Web Browsing-Productivity”) and then subsequently browse to a social networking site (classified based on the URL visited as “Web Browsing-Social Networking”). Distinct types of protocols have corresponding decoders.

Based on the determination made by application identification engine 242, the packets are sent, by threat engine 244, to an appropriate decoder configured to assemble packets (which may be received out of order) into the correct order, perform tokenization, and extract out information. Threat engine 244 also performs signature matching to determine what should happen to the packet. As needed, SSL encryption engine 246 can re-encrypt decrypted data. Packets are forwarded using a forward module 248 for transmission (e.g., to a destination).

As also shown in FIG. 2B, policies 252 are received and stored in management plane 232. Policies can include one or more rules, which can be specified using domain and/or host/server names, and rules can apply one or more signatures or other matching criteria or heuristics, such as for security policy enforcement for subscriber/IP flows based on various extracted parameters/information from monitored session traffic flows. Example policies can include C2 malware detection policies using the disclosed techniques for sample traffic based self-learning malware detection. An interface (I/F) communicator 250 is provided for management communications (e.g., via (REST) APIs, messages, or network protocol communications or other communication mechanisms).

### Security Platform

Returning to FIG. 1, suppose a malicious individual (using system 120) has created malware 130, such as malware for a malicious web campaign (e.g., the malware can be delivered to endpoint devices of users via a compromised web site when the user visits/browses to the compromised web site or via a phishing attack, etc.). The malicious individual hopes that a client device, such as client device 104, will execute a copy of malware 130 to unpack the malware executable/payload, compromising the client device, and, e.g., causing the client device to become a bot in a botnet. The compromised client device can then be instructed to perform tasks (e.g., cryptocurrency mining, or participating in denial of service attacks) and to report information to an external entity, such as command and control (C2/C&C) server 150, as well as to receive instructions from C2 server 150, as applicable.

Suppose data appliance 102 has intercepted an email sent (e.g., by system 120) to a user, “Alice,” who operates client device 104. In this example, Alice receives the email and clicks on the link to a phishing/compromised site that could result in an attempted download of malware 130 by Alice's client device 104. However, in this example, data appliance 102 can perform the disclosed techniques for sample traffic based self-learning malware detection and block access from Alice's client device 104 to the packed malware content and to thereby preempt and prevent any such download of malware 130 to Alice's client device 104. As will be further described below, data appliance 102 performs the disclosed techniques for sample traffic based self-learning malware detection, such as further described below, to detect and block such malware 130 from harming Alice's client device 104.

In various embodiments, data appliance 102 is configured to work in cooperation with security platform 122. As one example, security platform 122 can provide to data appliance 102 a set of signatures of known-malicious files (e.g., as part of a subscription). If a signature for malware 130 is included in the set (e.g., an MD5 hash of malware 130), data appliance 102 can prevent the transmission of malware 130 to client device 104 accordingly (e.g., by detecting that an MD5 hash of the email attachment sent to client device 104 matches the MD5 hash of malware 130). Security platform 122 can also provide to data appliance 102 a list of known malicious domains and/or IP addresses, allowing data appliance 102 to block traffic between enterprise network 140 and C2 server 150 (e.g., where C&C server 150 is known to be malicious). The list of malicious domains (and/or IP addresses) can also help data appliance 102 determine when one of its nodes has been compromised. For example, if client device 104 attempts to contact C2 server 150, such attempt is a strong indicator that client 104 has been compromised by malware (and remedial actions should be taken accordingly, such as quarantining client device 104 from communicating with other nodes within enterprise network 140).

As will be described in more detail below, security platform 122 can also receive a copy of malware 130 from data appliance 102 to perform cloud-based security analysis for performing sample traffic based self-learning malware detection, and the malware verdict can be sent back to data appliance 102 for enforcing the security policy to thereby safeguard Alice's client device 104 from execution of malware 130 (e.g., to block malware 130 from access on client device 104).

A variety of actions can be taken by data appliance 102 if no signature for an attachment is found, in various embodiments. As a first example, data appliance 102 can fail-safe, by blocking transmission of any attachments not allow-listed as benign (e.g., not matching signatures of known good files). A drawback of this approach is that there may be many legitimate attachments unnecessarily blocked as potential malware when they are in fact benign. As a second example, data appliance 102 can fail-danger by allowing transmission of any attachments not block-listed as malicious (e.g., not matching signatures of known bad files). A drawback of this approach is that newly created malware (previously unseen by platform 122) will not be prevented from causing harm. As a third example, data appliance 102 can be configured to provide the file (e.g., malware 130) to security platform 122 for static/dynamic analysis, to determine whether it is malicious and/or to otherwise classify it.

Security platform 122 stores copies of received samples in storage 142 and analysis is commenced (or scheduled, as applicable). One example of storage 142 is an Apache Hadoop Cluster (HDFS). Results of analysis (and additional information pertaining to the applications) are stored in database 146. In the event an application is determined to be malicious, data appliances can be configured to automatically block the file download based on the analysis result. Further, a signature can be generated for the malware and distributed (e.g., to data appliances such as data appliances 102, 136, and 148) to automatically block future file transfer requests to download the file determined to be malicious.

In various embodiments, security platform 122 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 122 can be implemented across a scalable infrastructure comprising multiple such servers, solid state drives, and/or other applicable high-performance hardware. Security platform 122 can comprise several distributed components, including components provided by one or more third parties. For example, portions or all of security platform 122 can be implemented using the Amazon Elastic Compute Cloud (EC2) and/or Amazon Simple Storage Service (S3). Further, as with data appliance 102, whenever security platform 122 is referred to as performing a task, such as storing data or processing data, it is to be understood that a sub-component or multiple sub-components of security platform 122 (whether individually or in cooperation with third party components) may cooperate to perform that task. As one example, security platform 122 can optionally perform static/dynamic analysis in cooperation with one or more virtual machine (VM) servers, such as VM server 124.

An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 122, but may also be provided by a third party. As one example, the virtual machine server can rely on EC2, with the remainder portions of security platform 122 provided by dedicated hardware owned by and under the control of the operator of security platform 122. VM server 124 is configured to provide one or more virtual machines 126-128 for emulating client devices. The virtual machines can execute a variety of operating systems and/or versions thereof. Observed behaviors resulting from executing applications in the virtual machines are logged and analyzed (e.g., for indications that the application is malicious). In some embodiments, log analysis is performed by the VM server (e.g., VM server 124). In other embodiments, analysis is performed at least in part by other components of security platform 122, such as a coordinator 144.

In various embodiments, security platform 122 makes available results of its analysis of samples via a list of signatures (and/or other identifiers) to data appliance 102 as part of a subscription. For example, security platform 122 can periodically send a content package that identifies malware files, including for network traffic based heuristic IPS malware detection, etc. (e.g., daily, hourly, or some other interval, and/or based on an event configured by one or more policies). The subscription can cover the analysis of just those files intercepted by data appliance 102 and sent to security platform 122 by data appliance 102, and can also cover signatures of malware known to security platform 122.

In various embodiments, security platform 122 is configured to provide security services to a variety of entities in addition to (or, as applicable, instead of) an operator of data appliance 102. For example, other enterprises, having their own respective enterprise networks 114 and 116, and their own respective data appliances 136 and 148, can contract with the operator of security platform 122. Other types of entities can also make use of the services of security platform 122. For example, an Internet Service Provider (ISP) providing Internet service to client device 110 can contract with security platform 122 to analyze applications which client device 110 attempts to download. As another example, the owner of client device 110 can install software on client device 110 that communicates with security platform 122 (e.g., to receive content packages from security platform 122, use the received content packages to check attachments in accordance with techniques described herein, and transmit applications to security platform 122 for analysis).

### Analyzing Samples Using Static/Dynamic Analysis

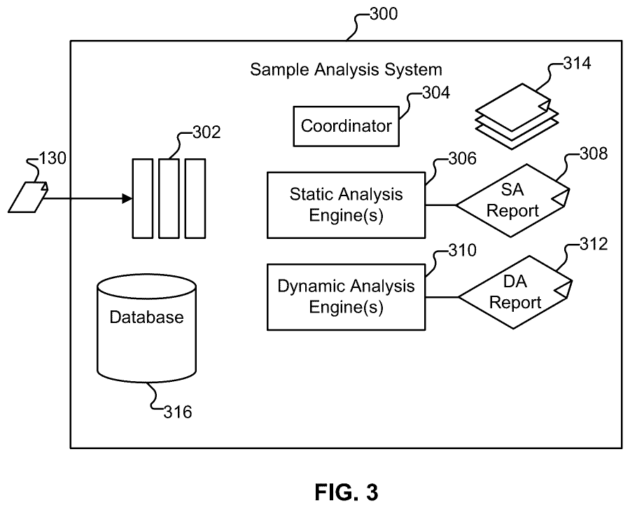

FIG. 3 illustrates an example of logical components that can be included in a system for analyzing samples. Analysis system 300 can be implemented using a single device. For example, the functionality of analysis system 300 can be implemented in a malware analysis module 112 incorporated into data appliance 102. Analysis system 300 can also be implemented, collectively, across multiple distinct devices. For example, the functionality of analysis system 300 can be provided by security platform 122.

In various embodiments, analysis system 300 makes use of lists, databases, or other collections of known safe content and/or known bad content (collectively shown in FIG. 3 as collection 314). Collection 314 can be obtained in a variety of ways, including via a subscription service (e.g., provided by a third party) and/or as a result of other processing (e.g., performed by data appliance 102 and/or security platform 122). Examples of information included in collection 314 are: URLs, domain names, and/or IP addresses of known malicious servers; URLs, domain names, and/or IP addresses of known safe servers; URLs, domain names, and/or IP addresses of known command and control (C2/C&C) domains; signatures, hashes, and/or other identifiers of known malicious applications; signatures, hashes, and/or other identifiers of known safe applications; signatures, hashes, and/or other identifiers of known malicious files (e.g., OS exploit files); signatures, hashes, and/or other identifiers of known safe libraries; and signatures, hashes, and/or other identifiers of known malicious libraries.

In various embodiments, when a new sample is received for analysis (e.g., an existing signature associated with the sample is not present in analysis system 300), it is added to queue 302. As shown in FIG. 3, application 130 is received by system 300 and added to queue 302.

Coordinator 304 monitors queue 302, and as resources (e.g., a static analysis worker) become available, coordinator 304 fetches a sample from queue 302 for processing (e.g., fetches a copy of malware 130). In particular, coordinator 304 first provides the sample to static analysis engine 306 for static analysis. In some embodiments, one or more static analysis engines are included within analysis system 300, where analysis system 300 is a single device. In other embodiments, static analysis is performed by a separate static analysis server that includes a plurality of workers (i.e., a plurality of instances of static analysis engine 306).

The static analysis engine obtains general information about the sample, and includes it (along with heuristic and other information, as applicable) in a static analysis report 308. The report can be created by the static analysis engine, or by coordinator 304 (or by another appropriate component) which can be configured to receive the information from static analysis engine 306. As an example, static analysis of malware can include performing a signature-based analysis. In some embodiments, the collected information is stored in a database record for the sample (e.g., in database 316), instead of or in addition to a separate static analysis report 308 being created (i.e., portions of the database record form the report 308). In some embodiments, the static analysis engine also forms a verdict with respect to the application (e.g., “safe,” “suspicious,” or “malicious”). As one example, the verdict can be “malicious” if even one “malicious” static feature is present in the application (e.g., the application includes a hard link to a known malicious domain). As another example, points can be assigned to each of the features (e.g., based on severity if found; based on how reliable the feature is for predicting malice; etc.) and a verdict can be assigned by static analysis engine 306 (or coordinator 304, if applicable) based on the number of points associated with the static analysis results.

Once static analysis is completed, coordinator 304 locates an available dynamic analysis engine 310 to perform dynamic analysis on the application. As with static analysis engine 306, analysis system 300 can include one or more dynamic analysis engines directly. In other embodiments, dynamic analysis is performed by a separate dynamic analysis server that includes a plurality of workers (i.e., a plurality of instances of dynamic analysis engine 310).

Each dynamic analysis worker manages a virtual machine instance (e.g., emulation/sandbox analysis of samples for malware detection, such as the above-described C2 malware detection based on monitored network traffic activity). In some embodiments, results of static analysis (e.g., performed by static analysis engine 306), whether in report form (308) and/or as stored in database 316, or otherwise stored, are provided as input to dynamic analysis engine 310. For example, the static report information can be used to help select/customize the virtual machine instance used by dynamic analysis engine 310 (e.g., Microsoft Windows 7 SP 2 vs. Microsoft Windows 10 Enterprise, or iOS 11.0 vs. iOS 12.0). Where multiple virtual machine instances are executed at the same time, a single dynamic analysis engine can manage all of the instances, or multiple dynamic analysis engines can be used (e.g., with each managing its own virtual machine instance), as applicable. As will be explained in more detail below, during the dynamic portion of the analysis, actions taken by the application (including network activity) are analyzed.

In various embodiments, static analysis of a sample is omitted or is performed by a separate entity, as applicable. As one example, traditional static and/or dynamic analysis may be performed on files by a first entity. Once it is determined (e.g., by the first entity) that a given file is malicious, the file can be provided to a second entity (e.g., the operator of security platform 122) specifically for additional analysis with respect to the malware's use of network activity (e.g., by a dynamic analysis engine 310).

The environment used by analysis system 300 is instrumented/hooked such that behaviors observed while the application is executing are logged as they occur (e.g., using a customized kernel that supports hooking and logcat). Network traffic associated with the emulator is also captured (e.g., using pcap). The log/network data can be stored as a temporary file on analysis system 300, and can also be stored more permanently (e.g., using HDFS or another appropriate storage technology or combinations of technology, such as MongoDB). The dynamic analysis engine (or another appropriate component) can compare the connections made by the sample to lists of domains, IP addresses, etc. (314) and determine whether the sample has communicated (or attempted to communicate) with malicious entities.

As with the static analysis engine, the dynamic analysis engine stores the results of its analysis in database 316 in the record associated with the application being tested (and/or includes the results in report 312 as applicable). In some embodiments, the dynamic analysis engine also forms a verdict with respect to the application (e.g., “safe,” “suspicious,” or “malicious”). As one example, the verdict can be “malicious” if even one “malicious” action is taken by the application (e.g., an attempt to contact a known malicious domain is made, or an attempt to exfiltrate sensitive information is observed). As another example, points can be assigned to actions taken (e.g., based on severity if found; based on how reliable the action is for predicting malice; etc.) and a verdict can be assigned by dynamic analysis engine 310 (or coordinator 304, if applicable) based on the number of points associated with the dynamic analysis results. In some embodiments, a final verdict associated with the sample is made based on a combination of report 308 and report 312 (e.g., by coordinator 304).

### Application Access Visibility Using an Application Access Analyzer (AAA)

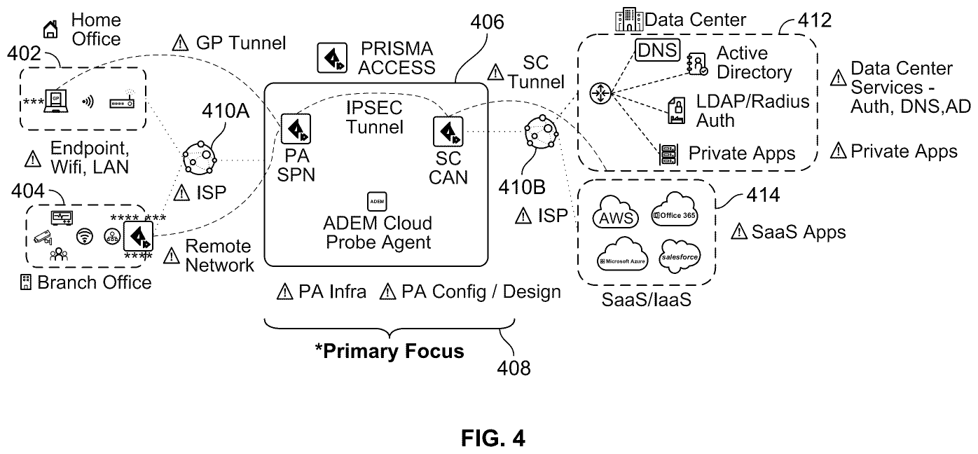

FIG. 4 is an example Secure Access Service Edge (SASE) and network environment that illustrates technical challenges for application access visibility in accordance with some embodiments. Specifically, FIG. 4 illustrates a home office 402 (e.g., via a VPN connection, such as using the GlobalProtect (GP) VPN tunnel as shown, which is a VPN solution that is commercially available from Palo Alto Networks, Inc, headquartered in Santa Clara, CA) and a branch office 404 (e.g., via a secure Remote Network as shown) that are in network communication with a SASE shown as Prisma Access 406 (e.g., Prisma Access is a SASE that is commercially available from Palo Alto Networks, Inc, headquartered in Santa Clara, CA) via a network/ISP shown at 410A. SASE/Prisma Access 406 is in network communication with a data center 412 and SaaS/IaaS 414 via a network/ISP shown at 410B.

Multiple computing components/entities and network connections between these different computing components/entities generally makes it technically challenging for a customer (e.g., a customer Network Operations Center (NOC) and/or IT/helpdesk personnel) to determine a root cause for any application connectivity issues. As a primary focus for SASE/Prisma Access 406, such as shown at 408, the disclosed techniques for the Application Access Analyzer provide an automated tool for the customer/customer NOC to analyze and detect potential access issues for a user(s)/group of users to access one or more applications (e.g., SaaS/Private Apps), such as will be further described below with respect to various embodiments.

Specifically, the disclosed techniques for the Application Access Analyzer (AAA) addresses various technical problems as will now be described. Mean Time To Detect (MTTD) and Mean Time To Recover (MTTR) for application (App) access issues are typically in hours, which can increase application downtime and adversely impact productivity of the customers/users and revenue for enterprises. Troubleshooting and debugging generally requires domain knowledge expertise. Further, co-relating and tracking multiple factors to perform Root Cause Analysis (RCA) is often cumbersome and error prone when performed manually.

For example, an enterprise and/or cloud service provider having multiple hosted network services, large network infrastructure, and complex security policy configuration can encounter significant challenges to reduce MTTR of App access issues.

As another example, identifying RCA in an enterprise organization can generally require comprehensive checks of various domains, such as network connectivity, infrastructure reachability, infrastructure availability, and security policy reasoning.

The disclosed Application Access Analyzer (AAA) provides an effective and efficient solution to the above-described problems, as will be further described below.

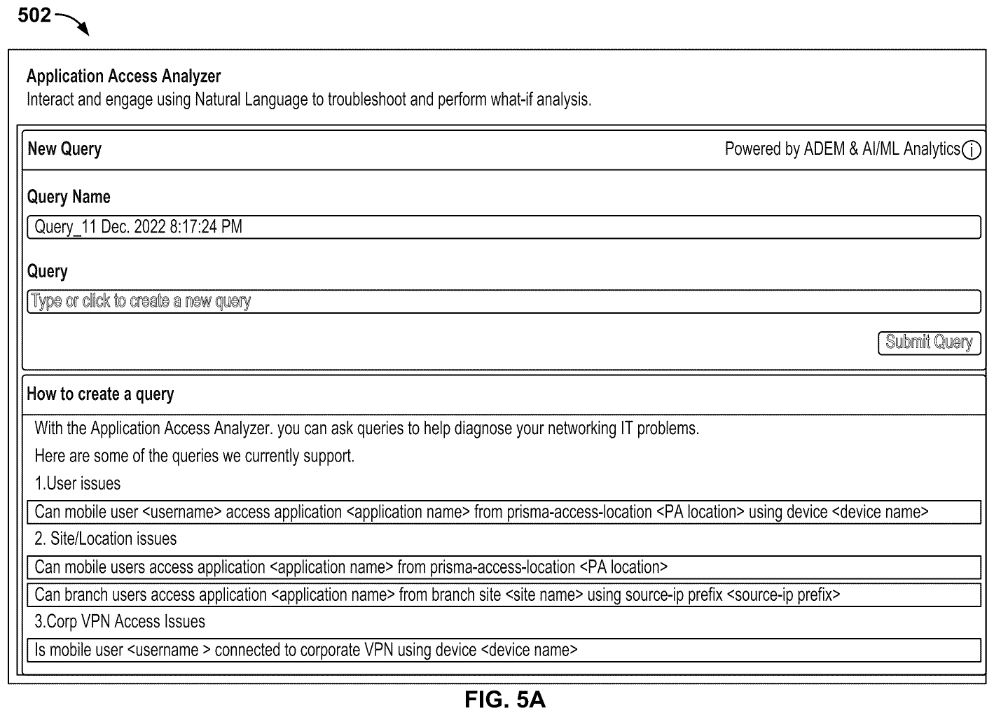

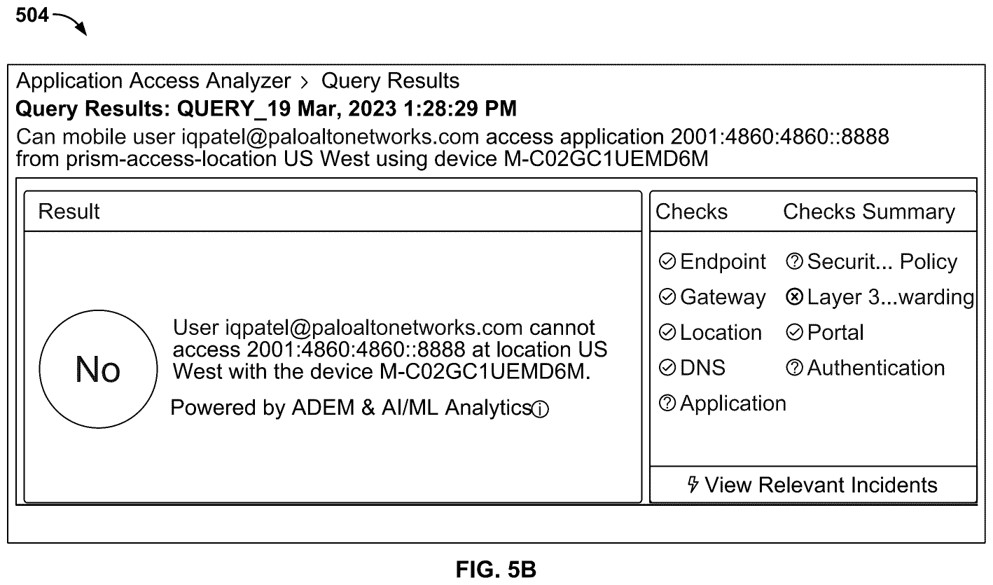

FIGS. 5A and 5B illustrate an example interface for an Application Access Analyzer (AAA) in accordance with some embodiments. Referring to FIG. 5A, AAA illustrates a natural language (NL) query (NLQ) interface to operators to detect application connectivity, reachability (e.g., infrastructure/network reachability), and permission issues as shown at 502.

Referring to FIG. 5B, the disclosed AAA solution can provide an Actionable verdict for a query submitted by a user (e.g., operator) with comprehensive analysis and checks performed in distinct domains, such as Layer 3 (L3) network reachability, network topology, DNS, Authentication, and security policy (e.g., security policy configuration, such as for access rights for a user to a particular resource) as shown at 504. For example, the disclosed AAA solution can be used for identifying and pinpointing the root cause, which significantly reduces the mean time to detect and resolve application access issues (e.g., from hours to minutes). As another example, the disclosed AAA solution can generate a human consumable verdict and analysis, which generally does not require IT operators to have domain knowledge expertise to identify the root cause of an issue/problem.

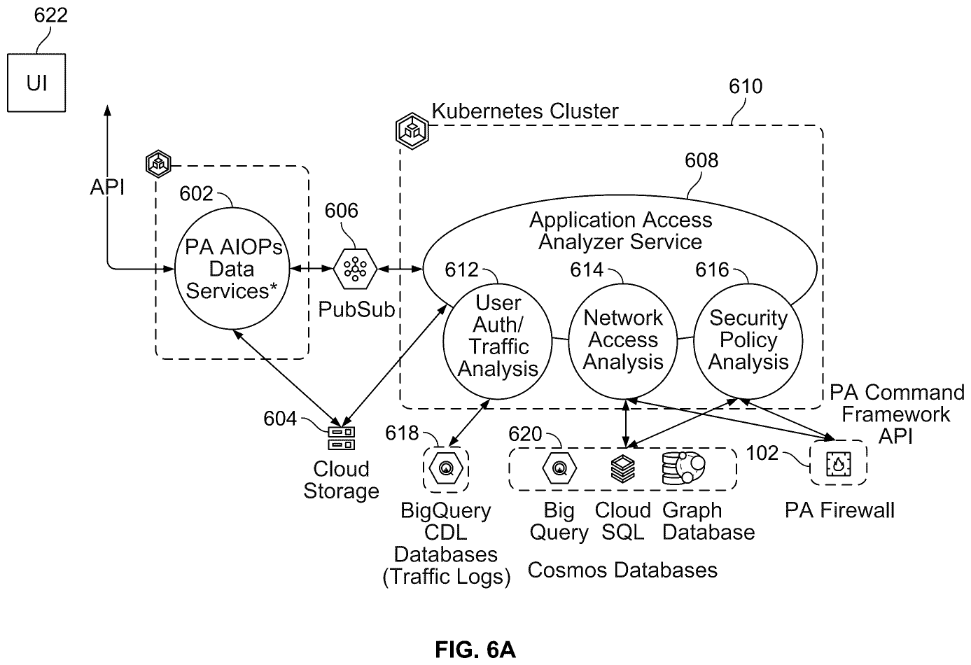

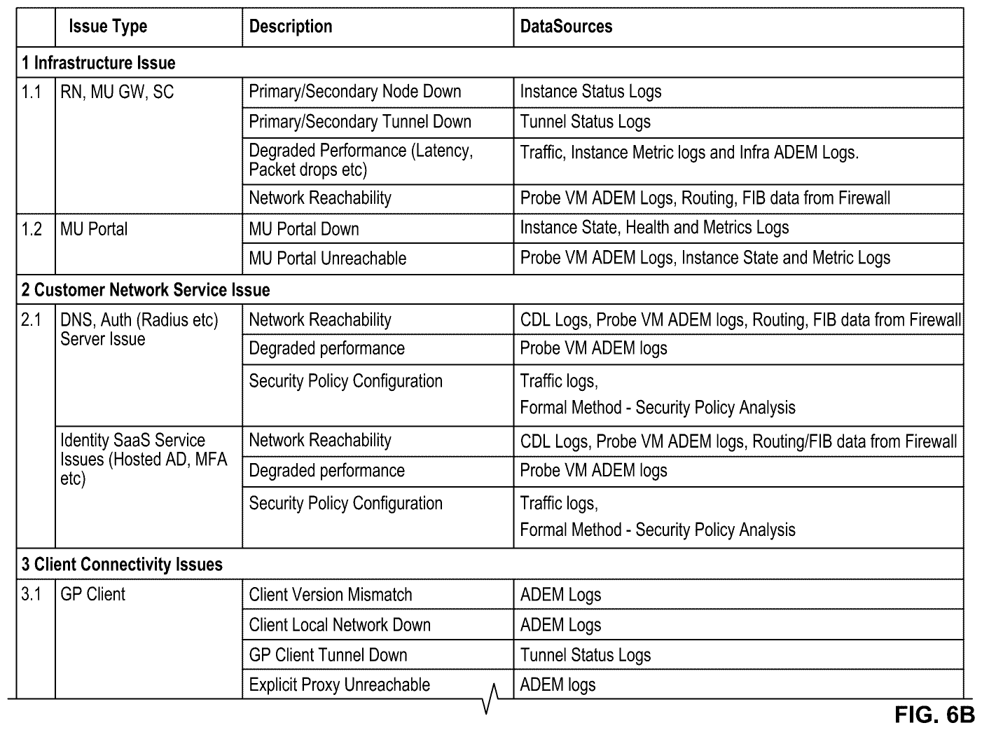

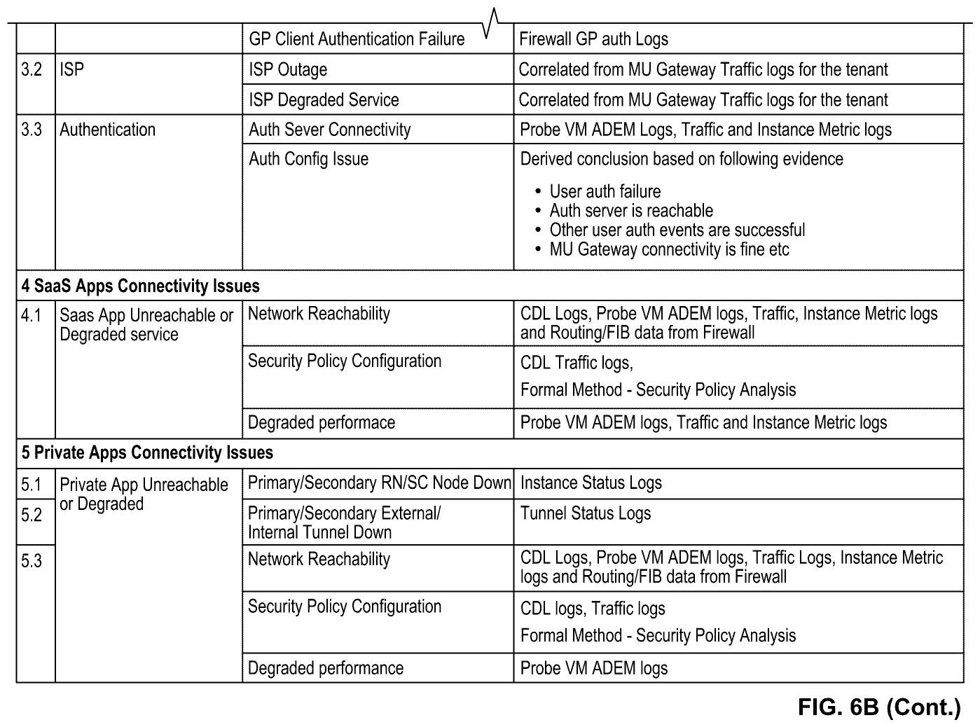

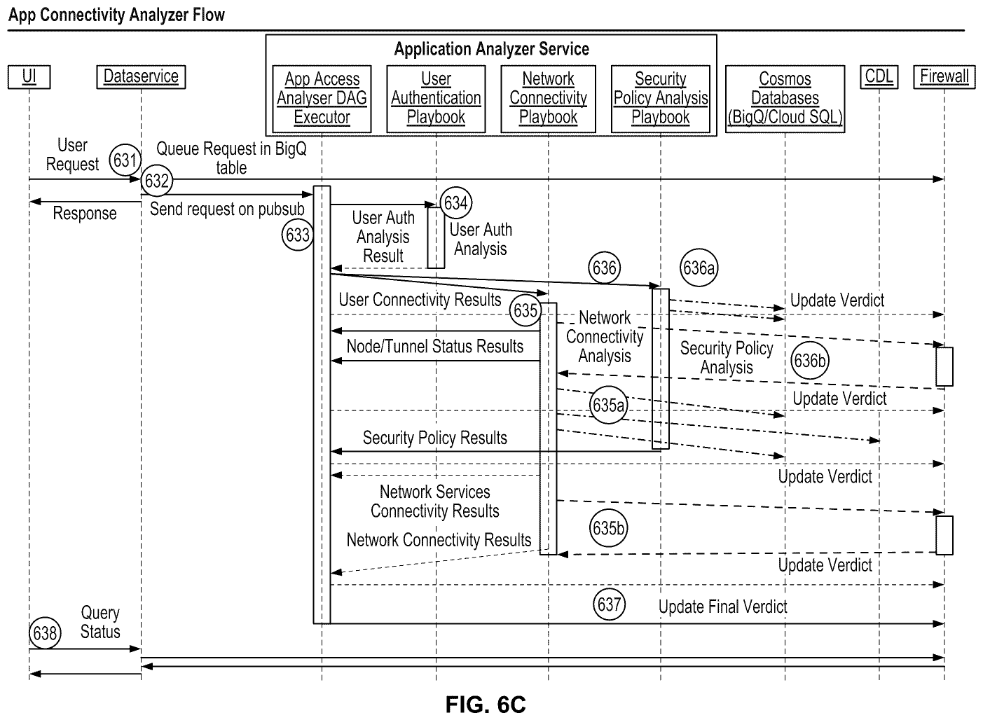

FIG. 6A illustrates a service architecture for the AAA in accordance with some embodiments. The AAA Service uses SASE/Prisma Access Topology, Firewall Configuration, Security Policy, Firewall Network Operational State (e.g., Routing, Forwarding Information Base (FIB), etc.), and other relevant firewall and authentication logs collected by SASE/Prisma Access Insights/AIOPs platform for providing a comprehensive connectivity analysis. Specifically, FIG. 6A illustrates an example implementation of an Application Access Analyzer (AAA) Service shown at 608 and provides a high-level view of the various components and data sources that are used in providing information for an application connectivity analysis. The degradation and outages generally can occur due to various reasons, such as further described below.

In an example implementation, the AAA Service (608) provides an automated solution for isolating faults and reducing mean time to detect and remediate issues. Specifically, the AAA Service checks for issues with the following: User Authentication; App Access Topology; Network Services (e.g., DNS, Auth Servers, etc.); SASE Access Nodes (e.g., Prisma Access Nodes, such as Mobile Gateways (MUs), Portals, Remote Networks (RNs), Service Connections (SCs), etc.); Network Reachability/Connectivity (e.g., Routes, etc.); Security Policy Analysis (e.g., Formal Methods, such as for validating permissions/access to a network/services/resource, etc.); Logs from various different sources (e.g., SASE/PA nodes, VPN/GP logs, Traffic logs, etc.); and/or Known Incidents (e.g., known ISP outages, Cloud Provider outages, Internal SASE/PA issues including underlay connectivity problems, etc.) impacting the connectivity.

As similarly described above, the AAA Service can also automatically generate a human consumable and an actionable verdict (e.g., a summary report/alert). The analysis can cover the following: (1) Infrastructure Issues (e.g., SASE/PA internal tunnels, nodes, underlay routing, overlay routing, etc.); (2) Customer Network Services Issues (e.g., Reachability to a DNS server, LDAP, Radius, etc.); (3) Client Connectivity Issues, including VPN/GP Client Connectivity Issues (e.g., the AAA Service can utilize the ADEM (agent details and MTR) logs for analyzing client connectivity issues (e.g., ADEM is an endpoint agent-based solution that is commercially available from Palo Alto Networks, Inc. headquartered in Santa Clara, CA, or another commercially available or open source endpoint agent can be similarly used)); (4) SaaS Apps Connectivity Issues, including SaaS Apps Reachability Issues; and (5) Private Apps Connectivity Issues, including Private Apps Reachability Issues.

FIG. 6B is a table summarizing the various different data sources used for example issues that are analyzed using the AAA Service (608) in accordance with some embodiments.

Referring to FIG. 6A, AAA Service 608 is implemented on a Kubernetes Cluster 610 as a container service to facilitate scalability (e.g., or another container-based or similar computing environment can be similarly used to implement the AAA service). AAA Service 608 includes the following components: a User Auth/Traffic Analysis component 612, a Network Access Analysis component 614, and a Security Policy Analysis component 616 (e.g., the network and security analysis playbook services can accept requests from the AAA Service). In an example implementation, the Playbooks are implemented as individual modules (e.g., implemented in Python or another high-level programming language) that perform specific User Authentication, Network Connectivity, and Security Policy Checks, such as further described below. AAA Service 608 is the core service that implements the User Connectivity checks. AAA Service 608 utilizes a plurality of network connectivity and security analysis playbooks, executing either locally or as playbook engine services, to gather evidence and determine the potential root cause of failures, such as will be further described below.

AAA service 608 is in network communication with a Cloud Storage 604 (e.g., a cloud-based data store, such as commercially available cloud-based storage solutions from Google Cloud, AWS, or another vendor can be used). User Auth/Traffic Analysis component 612 is in network communication with BigQuery CDL Databases 618 (e.g., storing traffic logs). Network Access Analysis component 614 is in communication with Cosmos Databases 620. Cosmos Databases 620 include a BigQuery database, a Cloud SQL database, and a Graph database as shown in FIG. 6A. Network Access Analysis component 614 and Security Policy Analysis component 616 are each in communication with a PA Firewall 102 (e.g., instance(s) of a commercially available firewall, such as the Palo Alto Networks (PA) firewall or another commercially available firewall) via an API (e.g., PA Command Framework API) for querying the firewalls (102), such as in real-time (e.g., querying operational state information of a firewall).

AAA service 608 is also in network communication with a PA AIOPs Data Services component 602. Specifically, AAA Service 608 is in network communication with PA AIOPs Data Services component 602 via a publish/subscribe (PubSub) communication mechanism as shown at 606.

As also shown in FIG. 6A, PA AIOPs Data Services component 602 is in communication with the user interface (UI) component 622 via an API. This container provides an API interface for the UI (e.g., an NL query UI). This service is a generic service that implements API for all PA AIOps services on the Cosmos platform. The AAA Service can expose specific endpoints to accept connectivity analysis requests from the UI and render corresponding results of the analysis. Further, the AAA Service provides a natural language (NL) query interface for users to analyze access issues (e.g., NL queries can be processed and sent to the AAA service as a structured query).

For example, the disclosed AAA Service can be used for checking connectivity between the following: (1) a User/Users/User Group to a SaaS application; (2) a User/Users/User Group to a Private Application hosted on premise data centers or on a remote branch office; (3) a User/Users/User Group to remote site connectivity (e.g., Remote branch (RN) or Data Center (SC)); (4) a Site to a Network; and (5) a Site to another Site.

FIG. 6C is a sequence diagram for an App Connectivity Analyzer using the AAA Service in accordance with some embodiments.

At 631, the Data service receives a ‘user to app’ connectivity query string. The UI accepts NLQ queries as similarly described above with respect to FIG. 6A.

At 632, the Data service creates a folder (e.g., a Google Cloud Service (GCS) folder) for each request and creates an entry in the AAA Query BigQuery (BQ) table. The UI can get the query status from the App Access Analyzer Query table. The Data service then posts the query string along with the GCS folder info to the AAA Service through a PubSub message. The final results of analysis are updated in the GCS folder and BQ table.

At 633, the AAA Service parses the query string and invokes one or more playbooks to analyze the user/users to application connectivity.

At 634, the Playbook Engine/Authentication Analysis Playbook gathers user authentication information. The results are published in the GCS folder and BQ table, and the playbook status is updated in the BigQuery table.

At 635, the Playbook Engine/Network Connectivity Analysis utilizes the network service analysis to check for network connectivity between a requested source and destination, and the verdicts can be updated as shown at 635A and 635B. The network service analysis is run for the following: Analyzing Network Services endpoint (e.g., DNS server, Auth Server, etc.) connectivity; and App Connectivity (e.g., verifying user to app connectivity). The network connectivity analysis uses the following sources for analysis: Instance Status, Tunnel Status, Instance Metrics, etc. (e.g., available on the Cosmos Platform), Cortex Data Lake (CDL) logs (e.g., a data repository for storing user-app traffic logs), and Firewall routing information. The results from the analysis and the Playbook status are stored in the GCS folder and BQ table.

In an example implementation, the User to Application Connectivity analysis utilizes the following Playbooks: (1) User Authentication Analysis; (2) Network Service Connectivity Analysis; (3) Network Service Security Policy Analysis; (4) User Network Connectivity Analysis; and (5) User Security Policy Analysis, such as will now be further described below.

In this example implementation, the User Authentication Analysis Playbook analyzes firewall auth logs for user authentication status. The User Authentication Analysis Playbook utilizes the following input parameters:

```
{
  ‘tenant_id’: <tenant_id>,
  ‘sub_tenant_id’: <sub_tenant_id>,
  ‘user_name’: <user name string>,
  ‘start_time’: <start timestamp> (optional - defaults to
  current time - 15 mins),
  ‘end_time’ : <end timestamp> (optional - defaults to current
  time)
}
```

The User Authentication Analysis Playbook returns the user auth status, device information, and gateway information for performing further analysis.

In this example implementation, the Network Service Connectivity Analysis Playbook utilizes the following input parameters:

```
{
  ‘tenant_id’: <tenant_id>,
  ‘sub_tenant_id’: <sub_tenant_id>,
  ‘source_ip’: <source IP>, (Optional)
  ‘destination_ip’: <network service endpoint IP>,
  ‘start_time’: <start timestamp> (optional - defaults to
  current time - 15 mins),
  ‘end_time’ : <end timestamp> (optional - defaults to current
time)
}
```

The network service IP addresses for the Auth Server, DNS server, etc. are fetched from the user provided configuration.

In this example implementation, the User Network Connectivity Analysis Playbook utilizes the following input parameters:

```
{
  ‘tenant_id’: <tenant_id>,
  ‘sub_tenant_id’: <sub_tenant_id>,
  ‘source_ip’: <Source Public IP address >,
  ‘destination_ip’ : <Destination FQDN or IP Address>,
  ‘gw_info’: {
    ‘cloud_provider’: <cloud provider info AWS | GCP >,
    ‘cloud_region_name’: <region name>,
    ‘instance_id’: <gateway instance id>
  }
  ‘start_time’: <start timestamp> (optional - defaults to
  current time - 15 mins),
  ‘end_time’ : <end timestamp> (optional - defaults to current
time)
}
```

For example, the DNS lookup on the firewall can map to multiple IP addresses. The connectivity check analysis is performed for all the IP addresses. If all of the IP addresses are reachable, then the Connectivity check passes. If any IP address reachability fails, then a Partial failure with associated analysis is returned in the result. If all IP addresses are not reachable, then the Connectivity check fails.

In this example implementation, the AAA Service calls a Formal Security Policy Analysis component (e.g., implemented as a Formal Security Policy Analysis library) with the following input parameters:

```
{
  “tenant_name”: “<tenant-name-string>”,
  “tenant_id”: “<tenant-id-string>”,
  “sub_tenant_id”: “<sub-tenant-id string>”,
  “location”: “<PA location - like “US West, US East, Ireland,
  ...>”,
  “node type id”: 48 (Remote Network/FWaaS), 49 (Mobile
  Gateway/GPaaS), 50 (Mobile User Portal/GPaaS),
51 (“Service Connection/SC”), 153 (“Explicit Proxy”) “
  “traffic_rule_matches”: [
  {
    “rule_matched_uuid”: “” or “rule_matched_uuid found in
    CDL traffic logs,
    “rule_matched”: “” or “rule_matched found in CDL traffic
    logs,
    “Source Zone”: “trust, untrust or any”,
    “Negate Source Address”: “no”,
    “Source Address”: “source ip address or a subnet for
    users query”,
    “Source User”: “any, user found in CDL logs or
    login_user_name provided in the query”,
    “Source Device”: “endpoint_device_name or any”,
    “Destination Zone”: “trust, untrust or any”,
    “Negate Destination Address”: “no”,
    “Destination Address”: “almost always specified using
    the destination ip address”,
    “Destination Device”: “any”,
    “Application”: “any or container_of_app or application
    found in CDL traffic logs”,
    “Service”: “any or specific category”,
    “URL Category”: “any or url_category as found in CDL
    traffic logs”
  },
  ...
  ]
}
```

The formal method security analysis function returns the following result.

```
{
  “summary_results”: {
    “config_info”: “Panorama Job ID”,
    “config_model”: “2022-03-31 19:47:28 UTC”,
    “result”: “Yes”
  },
  “policy_matches”: [ {
    “Disabled”: “no”,
    “Name”: “Allow-All”,
    “Source Zone”: [
      “any”
    ],
    “Negate Source Address”: “no”,
    “Source Address”: [
      “any”
    ],
    “Source User”: [
      “any”
    ],
    “Source Device”: [
      “any”
    ],
    “Destination Zone“: [
      “any“
    ],
    “Negate Destination Address”: “no”,
    “Destination Address”: [
      “any”
    ],
    “Destination Device”: [
      “any”
    ],
    “Application”: [
      “any”
    ],
    “Service”: [
      “any”
    ],
    “URL Category”: [
      “any”
    ],
    “Action”: “allow”,
    “Profile”: “none”,
    “Rule UUID”: “ce98dcae-df1e-4294-9443-3d58acc9854a”
  },
  ...
  ]
}
```

The AAA Service uses the security policy summary results to determine whether the security policy allows or denies access.

In this example implementation, the AAA Service checks for all user configured DNS servers. The AAA Service depends on the ADEM probe (ping and curl) test results (e.g., active probing for performing health analysis of Apps, such as SaaS/Private Apps) and collects unique DNS servers from the test results and checks or performs for the following: (1) Connectivity of the DNS server from each ingress node (e.g., Mobile Gateway (MU) or Remote Network (RN)) instance; (2) L3 forwarding path trace for the DNS server by running test FIB lookup command for each unique DNS server IP discovered in the test result; (3) Updates the topology for the DNS server connectivity based on L3 forwarding path; and (4) Queries each ingress firewall instance to look up match-rules for each DNS server. The DNS analysis result is returned in the result dictionary under key ‘DNS’ as follows: for each DNS server, the result includes match-rules highlighting which domain names are resolved by a particular DNS server, the L3 forwarding result, and security policy (if any) that prevents connectivity to the DNS server.

```
[
  {
    ...
    “dns”: {
      “status”: “Ok”,
      “health”: “Good”,
      “security_policy”: { },
    “l3_forwarding”: { } ,
    “servers”: {
        “DNS server ip address 1”: {
          “status”: “Ok”,
          “health”: “Good”,
          “nodes”: {
            “MU Gateway 1 FQDN” : {
            “status”: “Ok”,
            “health”: “Good”,
            “match-rule”: {
                “name”: “Private App DNS
                Server”,
                “domain-names”:
                [“*.panw.local”,
                “*.paloaltonetworks.loca
                l”]
              }
            },
            “MU Gateway 2 FQDN”: {
              “status”: “Ok”,
              “health”: “Good”,
              “match-rule”: {
                “name”: “Private App DNS
                Server”,
                “domain-names”:
                [“*.panw.local”,
                “*.paloaltonetworks.loca
                l”]
              }
            }
          }
        },
        “DNS server ip address 2”: {
        }
      }
    }
  ...
  }
]
```

In this example implementation, the AAA Service depends on the ADEM test result to check the Auth server connectivity. Specifically, the AAA Service queries the ADEM ping/curl test results for unique auth servers. The AAA Service summarizes the Auth server status for each ingress node. The auth server results are returned in the result dictionary under key “auth”.

```
[
  {
  ...
  “auth”: {
    “status”: “Ok”,
    “health”: “Good”,
      “security_policy”: { },
  “l3_forwarding”: { },
  “servers”: {
        “AUTH server ip address 1”: {
        “status”: “Ok”,
        “health”: “Good”,
    “auth_type”: “LDAP”,
    “test_type”: “ping” // or “curl”
    “nodes”: {
          “MU Gateway 1 FQDN”: {
            “status”: “Ok”,
            “health”: “Good”
          },
          “MU Gateway 2 FQDN”: {
            “status”: “Ok”,
            “health”: “Good”
          }
    }
        },
        “AUTH server ip address 2”: {...}
    }
  },
  ...
  }
]
```

At 636, the Security Policy Analysis performs a Formal Method analysis of security policies for the following: Network Service Endpoint connectivity; and App connectivity, and the verdicts can be updated as shown at 636A and 636B. The results from the analysis and the Playbook status are stored in the GCS folder and BQ table.

At 637, the AAA Service updates the status in the GCS folder and BQ table based on the results received from each playbook.

At 638, the AAA Service summarizes the connectivity analysis with the final results and updates the analysis status as completed.

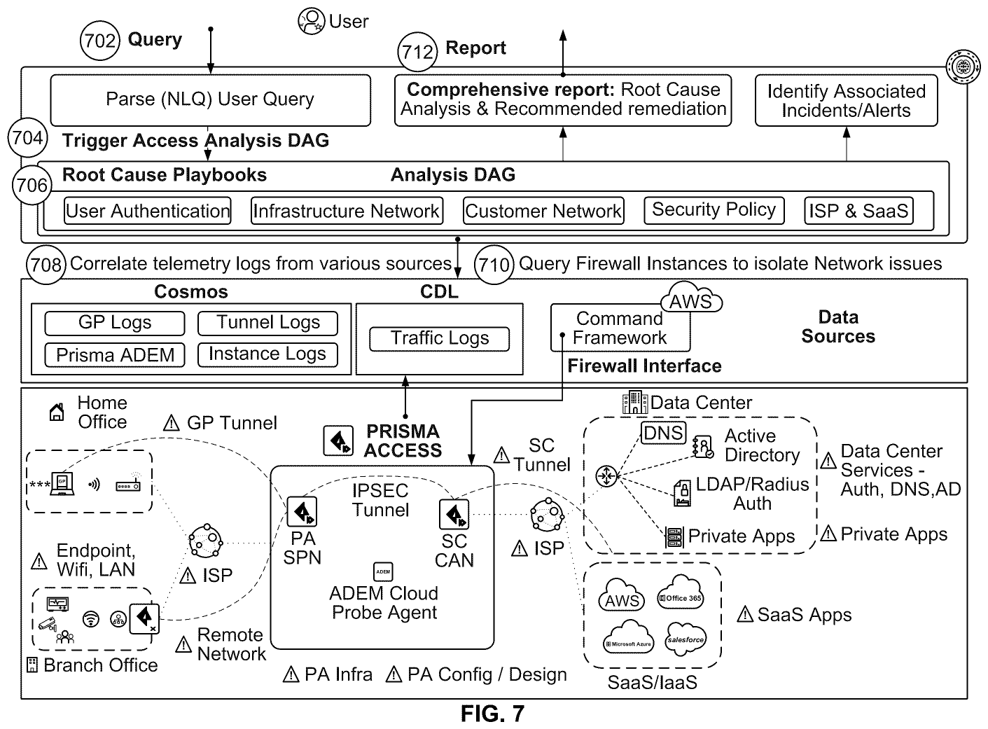

FIG. 7 illustrates the AAA in operation in accordance with some embodiments. As shown in FIG. 7, the AAA Service (e.g., shown as an App Analyzer in FIG. 7) includes an interface for user queries, a reporting component for generating comprehensive reports for root cause analysis (RCA) and recommended remediations, and an alerting module for generating alerts in response to identified events/incidents. The AAA Service also implements various DAGs shown as an Analysis DAG component that includes root cause playbooks for user authentication, infrastructure network, customer network, security policy, and ISP & SaaS. The AAA Service can communicate with various data sources that can correlate telemetry logs from various sources, such as VPN Logs (e.g., GlobalProtect (GP) logs), SASE Autonomous Digital Experience Management (ADEM) Logs (e.g., Prisma ADEM logs), Tunnel Logs (e.g., VPN tunnel logs, such as GP tunnel logs), Security Entity/Firewall Instance Logs, and Traffic Logs. The AAA Service includes a command framework (e.g., executed in the cloud (e.g., using Amazon Web Services (AWS) or another commercially available cloud solution)) that communicates with a firewall interface, such as with Prisma Access as shown in FIG. 7.

Referring to FIG. 7, at 702, the AAA provides a Query interface (e.g., an NLQ interface as described above with respect to FIGS. 5A and 5B) to a Customer NOC for troubleshooting application connectivity issues, such as described herein with respect to various embodiments.

At 704, the AAA executes DAGs (e.g., root cause playbooks as shown in FIG. 7) to identify a root cause for troubleshooting various application connectivity issues including root cause playbooks for user authentication, infrastructure network, customer network, security policy, and ISP & SaaS.

At 706, the Root Cause Playbooks of the Analysis DAG component perform authentication (e.g., user authentication), security (e.g., security policies), and network connectivity (e.g., infrastructure networks and customer networks as well as ISP and SaaS network access/connectivity issues) analysis using logs from various sources.

At 708, App analysis DAGs use one or more playbooks to gather evidence and correlate events including telemetry logs from various sources, such as VPN Logs (e.g., GlobalProtect (GP) logs), SASE Autonomous Digital Experience Management (ADEM) Logs (e.g., Prisma ADEM logs), Tunnel Logs (e.g., VPN tunnel logs, such as GP tunnel logs), Security Entity/Firewall Instance Logs, and Traffic Logs as shown in FIG. 7.

At 710, the Root Cause Playbooks of the Analysis DAG component also query firewalls (e.g., firewall instances of the Prisma Access SASE using the firewall interface as shown in FIG. 7) for further network fault isolation.

At 712, based on the automated user authentication, network, and security policy analysis, the AAA/App Access analyzer provides a comprehensive report and potential remediation steps using the reporting and/or alerting modules as shown in FIG. 7.

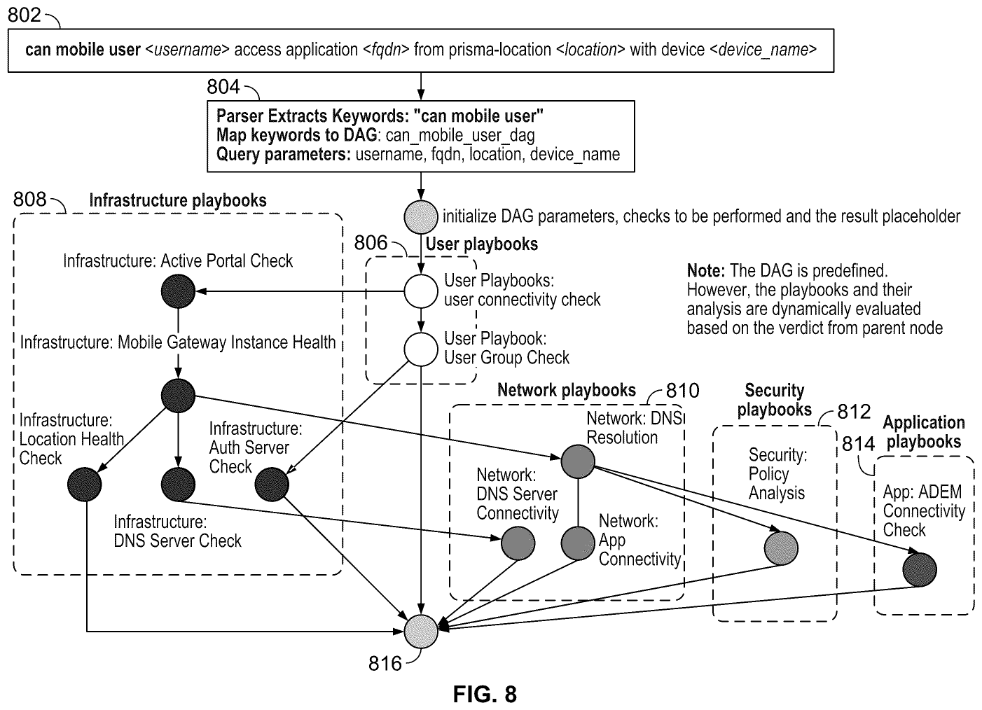

FIG. 8 illustrates an example implementation of the AAA that incorporates domain knowledge in the form of playbooks and can perform playbook analysis through execution of Directed Acyclic Graphs (DAGs) in accordance with some embodiments. As similarly described above, the AAA service can be configured to implement various DAGs. Specifically, FIG. 8 illustrates the processing for a ‘Can Mobile User’ DAG that can be performed by the AAA service.

Referring to FIG. 8, an example ‘Can Mobile User’ DAG is implemented as shown at 802, which includes the following parameters: a username, an access application specified by a Fully Qualified Domain Name (FQDN) as a target for the user's access analysis, and a PRISMA ACCESS location specified by a location that is associated with the user's device specified by a device name.

At 804, a Parser extracts keywords from the ‘Can Mobile User’ DAG and maps the extracted keywords to the ‘Can Mobile User’ DAG, which includes the above-described parameters: username, FQDN, location, and device name.

As 806, after processing initializes the extracted DAG parameters including checks to be performed by the result placeholder, processing proceeds to the User Playbooks to perform a User Connectivity Check, User Profile, and a user group check.

At 808, Infrastructure playbooks include performing an Active Portal Check for the User Connectivity Check. Processing proceeds to a Mobile Gateway Instance Health check, a Location Health Check, and an Infrastructure DNS Server Check. As also shown, the Infrastructure playbooks include performing an Auth Server Check for the User/User Group Check.

At 810, processing proceeds to Network Playbooks. At this stage of the DAG processing, the Network Playbooks processing includes performing a DNS Resolution check in response to the Mobile Gateway Instance Health check and then processing proceeds to the App Connectivity check. The Network Playbooks processing also includes performing a DNS Server Connectivity check in response to the DNS Server Check.

At 812, processing proceeds to Security Playbooks. At this stage of the DAG processing, the Security Playbooks processing includes performing a policy analysis (e.g., security policy analysis).

At 814, processing proceeds to Application Playbooks. At this stage of the DAG processing, the Application Playbooks processing includes performing an Autonomous Digital Experience Management (ADEM) connectivity check.

Finally, the health check results of the DAG processing from the Infrastructure playbooks, Network playbooks, Security playbooks, and Application playbooks are completed and provided to the results processing stage as shown at 816.

As will now be apparent to one of ordinary skill in the art, various other DAGs can be similarly implemented using the AAA service and associated playbooks and service infrastructure.

Various use case scenarios for the disclosed AAA solution will now be further described below.

### Use Case Scenarios

As a first example use case scenario, the disclosed AAA solution can be applied to facilitate effectively and efficiently performing a root cause and/or other analysis for access for a user(s) and/or a group of users to a SaaS application from Mobile user Gateways.

As a second example use case scenario, the disclosed AAA solution can be applied to effectively and efficiently facilitate performing a root cause and/or other analysis for access for a user(s) and/or a group of users to a Private Application hosted on-premises data centers or on a remote branch office.

As a third example use case scenario, the disclosed AAA solution can be applied to facilitate effectively and efficiently performing a root cause and/or other analysis for access for a user(s) and/or a group of users from a remote site to a Remote branch or a Data Center.

Various process embodiments for an application access analyzer (AAA) will now be further described below.

### Example Processes for an Application Access Analyzer (AAA) Service

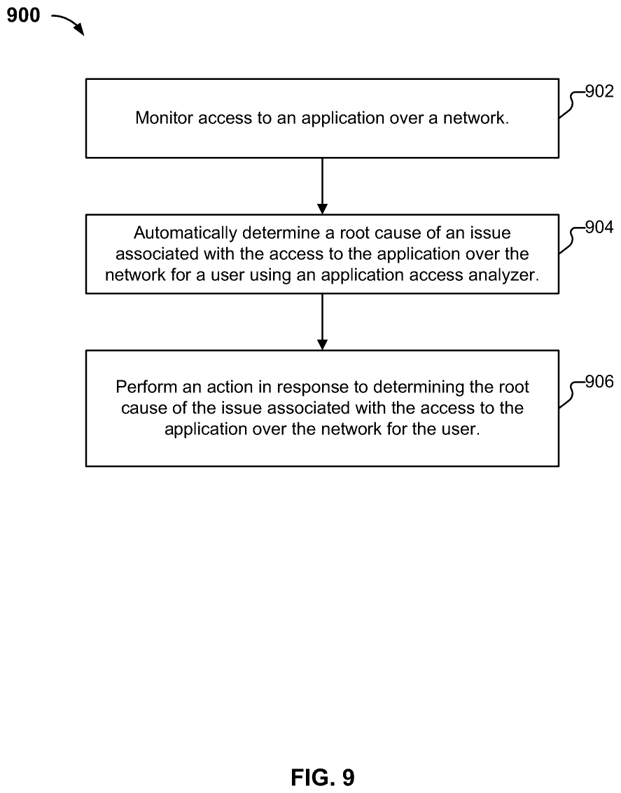

FIG. 9 is a flow diagram of a process for the AAA Service in accordance with some embodiments. In some embodiments, a process 900 as shown in FIG. 9 is performed by the AAA Service and techniques as similarly described above including the embodiments described above with respect to FIGS. 4-8.

At 902, access to an application over a network is monitored, such as similarly described above with respect to FIGS. 4-8.

At 904, a root cause of an issue associated with the access to the application over the network for a user (e.g., a specified user or group of users) is automatically determined using an application access analyzer, such as similarly described above with respect to FIGS. 4-8.

At 906, an action is performed in response to determining the root cause of an issue associated with the access to the application over the network for the user, such as similarly described above with respect to FIGS. 4-8.

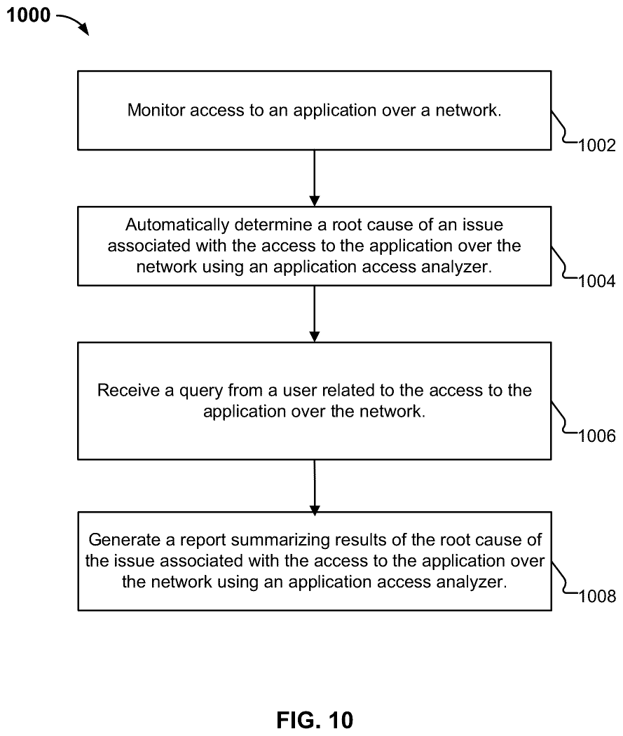

FIG. 10 is another flow diagram of a process for the AAA Service in accordance with some embodiments. In some embodiments, a process 1000 as shown in FIG. 10 is performed by the AAA Service and techniques as similarly described above including the embodiments described above with respect to FIGS. 4-8.

At 1002, access to an application over a network is monitored, such as similarly described above with respect to FIGS. 4-8.

At 1004, a root cause of an issue associated with the access to the application over the network (e.g., for a specified user or group of users) is automatically determined using an application access analyzer, such as similarly described above with respect to FIGS. 4-8.

At 1006, a query is received from a user related to the access to the application over the network. For example, the application access analyzer can support the processing of a natural language query (e.g., NL queries can be processed and sent to the AAA service as a structured query) as similarly described above with respect to FIGS. 4-8.

At 1008, a report summarizing results of the root cause of the issue associated with the access to the application over the network (e.g., for the specified user or group of users) is generated using the application access analyzer, such as similarly described above with respect to FIGS. 4-8.

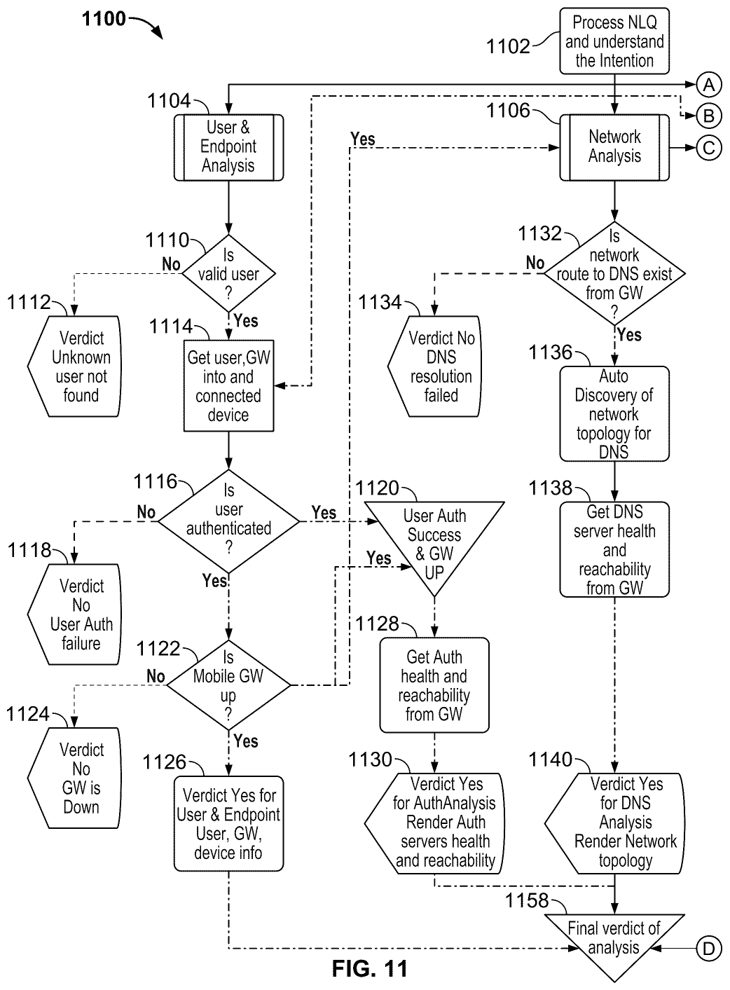

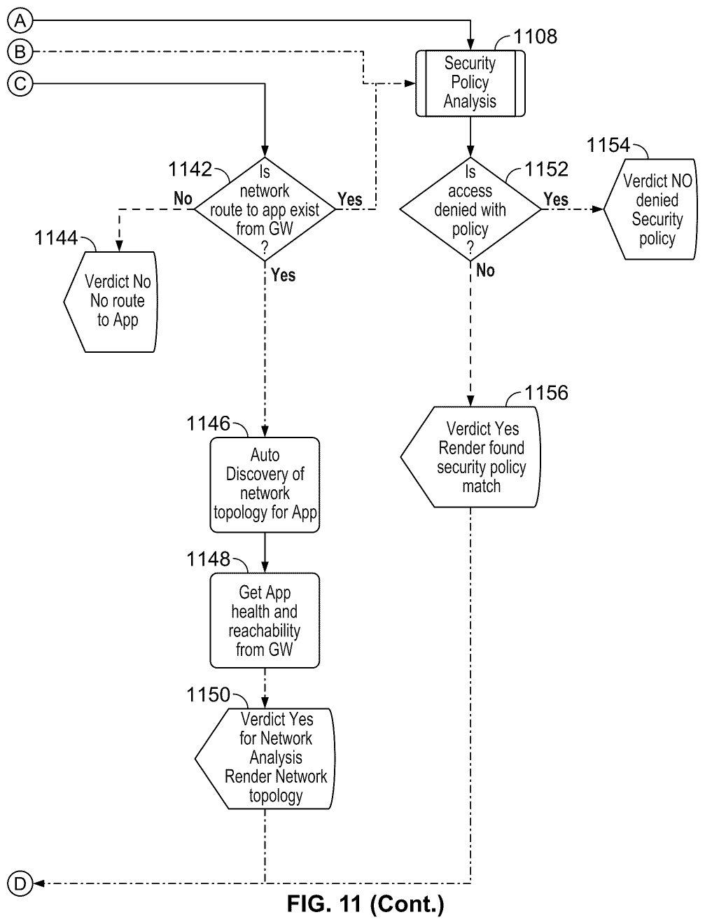

FIG. 11 is another flow diagram of a process for the AAA Service in accordance with some embodiments. In some embodiments, a process 1100 as shown in FIG. 11 is performed by the AAA Service and techniques as similarly described above including the embodiments described above with respect to FIGS. 4-8.

Referring to FIG. 11, a natural language query (NLQ) is received and processed using the above-described AAA Service as shown at 1102. The AAA Service automatically performs various analyses to facilitate determining potential access issues to an application (e.g., a SaaS/Private App) including the following: (1) User and Endpoint Analysis as shown starting at 1104; (2) Network Analyses as shown starting at 1106; and (3) Security Policy Analysis as shown starting at 1108 in FIG. 11 and as will each be further described below.

Referring to the User and Endpoint Analysis as shown starting at 1104 in FIG. 11, the processing is initiated at 1110 by determining whether the user is a valid user. If not, then the verdict is Unknown as the user is not found as shown at 1112. Otherwise, processing proceeds to 1114 and the AAA service gets the user and gateway (GW) information and the connected device information associated with the user. At 1116, whether the user is authenticated is determined. If not, then the verdict is determined as a user authentication (Auth) failure as shown at 1118. At 1122 (e.g., user authentication was verified), whether the mobile GW is up and running is determined. If not, then the verdict is determined as the GW is down as shown at 1124. At 1126 (e.g., mobile GW is up and running is verified), then the verdict is determined as Yes for user, user's endpoint device, GW and that information is provided to the final verdict analysis as shown at 1158. Processing also proceeds from 1116 and 1122 to 1120 as user authentication was successful and the GW is verified to be up and running. At 1128, the AAA Service verifies the Auth server's health and its reachability from the GW. At 1130, the verdict is determined as Yes for the Auth analysis and is rendered for Auth server's health and reachability, and this verdict information is similarly sent to the final verdict analysis at 1158.

Referring to the Network Analysis as shown starting at 1106 in FIG. 11, the processing is initiated at 1132 by determining whether the network route from the GW to the DNS server exists. If not, then the verdict is determined as DNS resolution failed as shown at 1134. Otherwise, processing proceeds to perform auto discovery of the network topology for DNS as shown at 1136. At 1138, the AAA service determines the DNS server health and its reachability from the GW. At 1140, the verdict is determined as Yes for the DNS analysis and is rendered for the network topology, and this verdict information is similarly sent to the final verdict analysis at 1158. As shown at 1142, the Network Analysis includes determining whether the network route from the GW to the App (e.g., SaaS/private app) exists. If not, then the verdict is determined as no network route from the GW to the App exists as shown at 1144. Otherwise, processing proceeds to perform auto discovery of the network topology for the App as shown at 1146. At 1148, the AAA service determines the App health and its reachability from the GW. At 1150, the verdict is determined as Yes for the network analysis and is rendered for the network topology, and this verdict information is similarly sent to the final verdict analysis at 1158.

Referring to the Security Policy Analysis as shown starting at 1108 in FIG. 11, the processing is initiated at 1152 by determining whether the access is denied with the policy (e.g., security policy). If so (i.e., access is denied under the security policy), then the verdict is determined as NO as that access is denied under the security policy as shown at 1154. Otherwise (i.e., access is not denied under the security policy), the verdict is determined as Yes as a security policy match is found, and this verdict information is similarly sent to the final verdict analysis at 1158.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
monitor access to an application over a network;
automatically determine a root cause of an issue associated with the access to the application over the network for a user using an application access analyzer; and
perform an action in response to determining the root cause of the issue associated with the access to the application over the network for the user; and
a memory coupled to the processor and configured to provide the processor with instructions.

2. The system of claim 1, wherein the application access analyzer determines the root cause of the issue associated with the access to the application over the network for the user by correlating a plurality of data sources across a plurality of domains using artificial intelligence and/or machine learning, and wherein the plurality of domains includes network, authentication, DNS, SaaS/Private App health, and security policy configuration.

3. The system of claim 1, wherein the application access analyzer automatically detects an anomaly in network connectivity and/or a performance degradation associated with the access to the application over the network for the user or a group of users.

4. The system of claim 1, wherein the action includes generating a human consumable and actionable verdict analysis that reduces a mean time to detect and remediate application connectivity issues.

5. The system of claim 1, wherein the automatically determining the root cause of the issue associated with the access to the application over the network for the user using the application access analyzer includes identifying a network infrastructure issue, a customer network services issue, client connectivity issue, SaaS/private application (app) health issue, and/or other connectivity/reachability or performance degradation issue.

6. The system of claim 1, wherein the application access analyzer auto discovers a network topology that is used by the user to access the application.

7. The system of claim 1, wherein the application access analyzer performs a security posture evaluation by building a unified logical model of computation for security policies associated with an enterprise network.

8. The system of claim 1, wherein the processor is further configured to:
monitor network topology issues using the application access analyzer.

9. The system of claim 1, wherein the processor is further configured to:
monitor network configuration issues using the application access analyzer.

10. The system of claim 1, wherein the processor is further configured to:
monitor network services issues using the application access analyzer.

11. The system of claim 1, wherein the processor is further configured to:
monitor security policy issues using the application access analyzer.

12. The system of claim 1, wherein the processor is further configured to:
process a user query using a natural language query interface of the application access analyzer.

13. A method, comprising:
monitoring access to an application over a network;
automatically determining a root cause of an issue associated with the access to the application over the network for a user using an application access analyzer; and
performing an action in response to determining the root cause of the issue associated with the access to the application over the network for the user.

14. The method of claim 13, wherein the application access analyzer determines the root cause of the issue associated with the access to the application over the network for the user by correlating a plurality of data sources across a plurality of domains using artificial intelligence and/or machine learning, and wherein the plurality of domains includes network, authentication, DNS, SaaS/Private App health, and security policy configuration.

15. The method of claim 13, wherein the application access analyzer automatically detects an anomaly in network connectivity and/or a performance degradation associated with the access to the application over the network for the user or a group of users.

16. The method of claim 13, wherein the action includes generating a human consumable and actionable verdict analysis that reduces a mean time to detect and remediate application connectivity issues.

17. The method of claim 13, wherein the automatically determining the root cause of the issue associated with the access to the application over the network for the user using the application access analyzer includes identifying a network infrastructure issue, a customer network services issue, client connectivity issue, SaaS/private application (app) health issue, and/or other connectivity/reachability issue or performance degradation issue.

18. The method of claim 13, wherein the application access analyzer auto discovers a network topology that is used by the user to access the application.

19. The method of claim 13, wherein the application access analyzer performs a security posture evaluation by building a unified logical model of computation for security policies associated with an enterprise network.

20. A computer program product embodied in a non-transitory computer readable medium and comprising computer instructions for:
monitoring access to an application over a network;
automatically determining a root cause of an issue associated with the access to the application over the network for a user using an application access analyzer; and
performing an action in response to determining the root cause of the issue associated with the access to the application over the network for the user or a group of users.
